(19) United States
(12) Patent Application Publication
(10) Pub. No.: US 2007/0205862 A1
(43) Pub. Date: Sep. 6, 2007

(54) Method and device for automatically locking the doors of a vehicle

(76) Inventor: Alain Brillon, Villeneuve Tolosane (FR)

Correspondence Address: YOUNG & THOMPSON, 745 SOUTH 23RD STREET, 2ND FLOOR, ARLINGTON, VA, 22202, US

(21) Appl. No.: 11/708,025

(22) Filed: Feb. 20, 2007

(30) Foreign Application Priority Data
Feb. 21, 2006 (FR) 0601495

(51) Int. Cl. B60R 25/00

(52) U.S. Cl. 340/5.72; 340/10.1; 340/5.61; 340/426.36

(57) ABSTRACT

To avoid the untimely locking of the exits of a vehicle 1 using a hands-free locking/unlocking device by detecting the proximity to the vehicle of an identifying device 2, the method comprises measurement of the radio frequency noise level present on the antenna of the identifying device in the frequency range of the request signals transmitted by the system on board the vehicle 1.

When the noise level is sufficiently high and the request signal is not received by the identifying device 2, the transmission of the locking signal, which is normally transmitted when the request signal stops being received because of the distance of the identifying device 2 from the vehicle 1, is inhibited.

The present invention belongs to the field of devices for locking and unlocking the exits of vehicles. More particularly, the invention relates to a method of remotely locking/unlocking the exits of a vehicle by a so-called hands-free device and which avoids the unwanted locking of the exits in situations where such locking is not desirable.

To prevent or allow access to a vehicle, remote control devices are increasingly being used, which lock the exits of the vehicle by transmitting a signal which is received by the vehicle with the effect of ordering the closure of the locks on the various exits or which, conversely, allows access to the vehicle by transmitting a signal, also received by the vehicle, with the effect of ordering or enabling the opening of the locks of the exits.

Among the known systems for locking/unlocking the exits of a vehicle, the so-called hands-free systems are particularly appreciated by users because they require no intervention on their part when they want to access their vehicle or leave the latter in a secured way.

Such hands-free systems are normally based on the detection in the vicinity of the vehicle of a portable transmitter-receiver, called identifying device, carried by the person needing to access the interior of the vehicle. This identifying device operates according to the principle of transponders; it transmits signals according to signals received.

Thus, in a first step, a unit on board the vehicle transmits a first signal, carrying an identification code, at regular intervals. This first signal is received by the identifying device if the latter is sufficiently close to the vehicle. The powers transmitted by the transmitter of the vehicle and the sensitivity of the identifying device make it possible to set in practice at a few meters, the distance from which the identifying device will detect the signal.

In a second step, the identifying device, when it is paired with the vehicle (that is, when it identifies the received signal as being intended for it from the identification code), which receives signals, reacts by transmitting signals itself, coded for reasons of security, which are received and interpreted by the vehicle. The signals transmitted by the identifying device in response to the signal transmitted by the vehicle are interpreted by the unit on board the vehicle as the proximity of the identifying device and as having to allow access to the vehicle.

When the identifying device which was receiving the signals from the vehicle to which it is paired no longer receives signals, it transmits a second signal conveying an indication that is interpreted by the vehicle that receives it as a moving away of the identifying device and as having to lock the access to the vehicle. Obviously, for satisfactory operation, the second signal transmitted by the identifying device must be received by the vehicle when the identifying device no longer detects the first signal transmitted by the vehicle because of its moving away from the vehicle.

To obtain this result, in addition to the powers transmitted by the vehicle and the identifying device, use is most commonly made of radio frequency transmitters for the vehicle in the low-frequency domain, called LF, for example in the 125 kHz range, and, for the identifying device, frequencies in the radio domain, called RF, for example in the 433 MHz range.

This choice makes it possible, among other things, to produce small-size identifying devices which can be incorporated in badges or in other media.

Detailed operation of a hands-free system for locking/unlocking a vehicle is described in the French patent application published under the number 2 847 610.

In this application, the system uses an identifying device which measures the level of the signal received from the vehicle and which transmits a signal to the vehicle which depends on the received signal level.

However, in such known systems, the identifying device transmits a second signal to lock the exits when the LF signal transmitted by the vehicle is no longer received, even if the identifying device is still within an area where it would have been able to receive the LF signal, but is no longer able to detect said LF signal. This situation is particularly problematic because the exits of the vehicle can be locked while the identifying device is inside the vehicle, for example, in a jacket or a bag left in the vehicle, while the assumed occupant or occupants of the vehicle are outside and cannot get into it.

The most probable cause, apart from failure situations, for which the first LF signal transmitted by the vehicle is no longer received within the normal reception perimeter, is the presence of disturbing signals in the frequency range of the LF signal.

The presence of such signals is increasingly common because of the numerous fixed or mobile units, such as cellular telephones, GPS receivers, video gaming consoles, etc. that can be in the vicinity of the identifying device.

If the intensity of these undesirable signals close to the identifying device is abnormally high, of the same order as or greater than that of the LF signal that has to be received, the receiver of the identifying device will no longer be able to distinguish the wanted signal from the radio frequency noise.

In order to eliminate such a risk, or at least to reduce it to a very low level at which it becomes acceptable, the invention proposes a hands-free method of locking/unlocking the exits of a vehicle which comprises, in a known manner:
a) the transmission by a unit on board the vehicle of a first radio frequency signal, called request signal;
b) the transmission by an identifying device, mobile relative to the vehicle, of a second radio frequency signal, called presence signal, in response to the reception of the request signal;
c) the transmission by the identifying device of a third radio frequency signal, called locking signal, if the request signal is not received within a time interval within which such a request signal is expected;
   and which, unlike the known devices, further comprises:
d) at least one measurement by the identifying device of the intensity of the radio frequency field surrounding said identifying device in the frequency domain of the request signal when the expected request signal is not received;
e) the inhibition of the transmission of the locking signal, that is, the noncompletion of the step c) of the known method, if the intensity of the radio frequency field is greater than a threshold value.

Thus, when the request signal cannot be detected because of a radio frequency noise of an abnormally high level, the identifying device does not transmit the signal needed to trigger the locking of the exits of the vehicle.

Advantageously, the radio frequency field is measured on expiry of a time delay δt, during which an expected request signal has not been received by the identifying device.

Alternatively, in order to obtain a more comprehensive indication of the level of ambient radio frequency noise, the intensity of the radio frequency field compared to the threshold value is deduced from one or more measurements of the intensity of the radio frequency field performed before the expiry of a time delay δt during which an expected request signal has not been received by the identifying device.

When the locking signal is inhibited, the identifying device transmits no signal or indeed transmits a presence signal for the onboard unit to be informed of the presence of the identifying device if the latter is actually within its reception perimeter.

Advantageously, when a locking signal is inhibited and the identifying device transmits a presence signal, this presence signal contains an indication, designed to be processed by the onboard unit, characterized by the fact that said presence signal is transmitted if a request signal is not received and if there is an abnormally high noise level in the frequency domain of the request signal.

The threshold value of the measured intensity of the radio frequency field, above which the transmission of the locking signal is inhibited, is fixed or even is fixed by the identifying device based on the contents of signals transmitted by the onboard unit.

To implement the method, the invention also relates to a hands-free device for locking/unlocking the exits of a vehicle, comprising:
a unit on board the vehicle suitable for transmitting a periodic radio frequency signal, called request signal;
at least one identifying device, mobile relative to the vehicle suitable for receiving the request signal, suitable for transmitting a radio frequency signal or presence signal in response to the reception of a request signal and suitable for transmitting at least one radio frequency signal or locking signal when the identifying device stops receiving request signals;
   said mobile identifying device further comprising means of measuring the radio frequency field in the frequency domain of the request signals and means for inhibiting the transmission of the locking signal according to the result of at least one measurement of the radio frequency field when an expected request signal is not received.

In order to verify if the signal not having been received might have been masked by the radio frequency noise, the at least one identifying device comprises means for comparing the value of the radio frequency field measured or estimated from measurements with a threshold value and for inhibiting the transmission of the locking signal in the case where said value of the radio frequency field is greater than said threshold.

The identifying device, when said locking signal is inhibited, can remain silent, or indeed transmit a presence signal identical to the signal transmitted in response to a received request signal or indeed generate and transmit a presence signal comprising an indication characteristic of the fact that said presence signal is transmitted if a request signal is not received and if there is an abnormally high radio frequency noise level in the frequency domain of the request signals.

In the latter case, the unit on board the vehicle advantageously comprises means for extracting from the presence signal the indication characterizing that said presence signal is transmitted if a request signal is not received in order to process this indication in the locking algorithms that can take account of other parameters.

To make best use of the propagation properties of the radio frequency signals, the request signals are preferably transmitted in a low-frequency range close to 125 kHz and the presence and locking signals are preferably transmitted in a high-frequency range close to 433 MHz.

The detailed description of the invention is given with reference to the figures which represent:

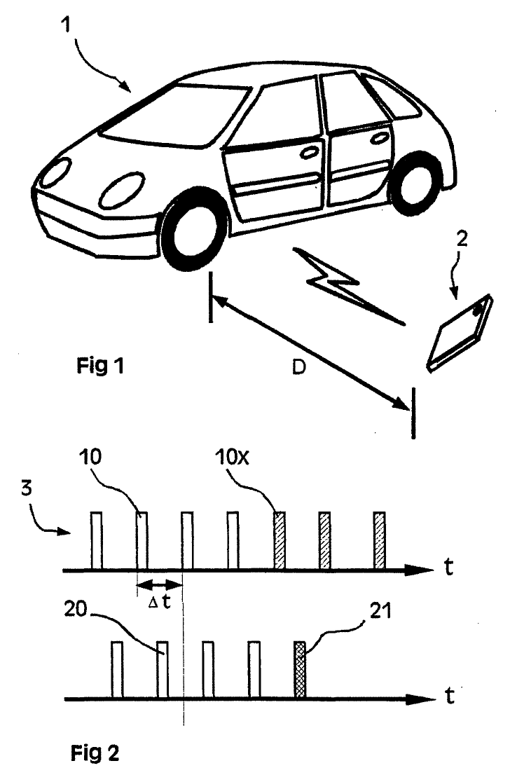

FIG. 1: general principle by detection of the proximity of an identifying device of a hands-free system for locking/unlocking the exits of a vehicle.

FIG. 2: the known principle of operation of an identifying device in transponder mode transmitting signals according to the signals received from a system on board the vehicle.

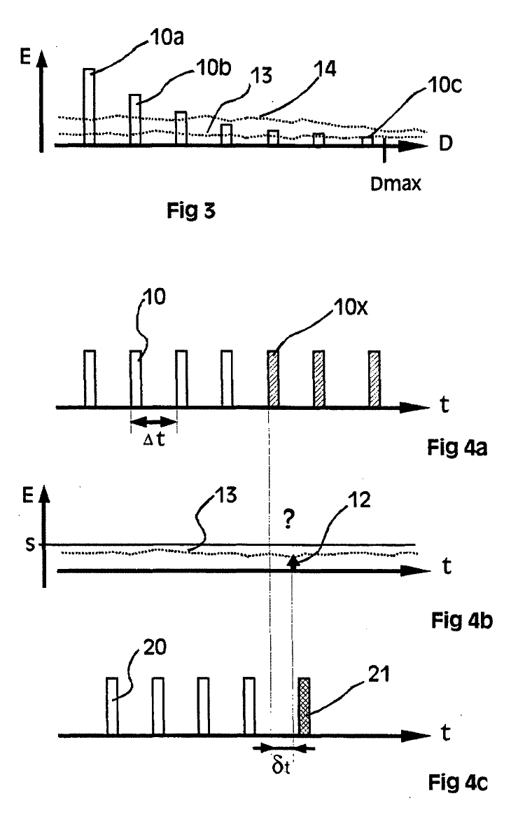

FIG. 3: the trend of the intensity of the request signal transmitted by the unit on board the vehicle received by the identifying device according to the distance between the identifying device and the vehicle, and compared with different radio frequency noise levels.

FIGS. 4a, 4b and 4c: timing diagrams respectively of the request signals transmitted by a unit on board the vehicle, of the measurement performed by the identifying device of the intensity of the ambient radio frequency field in the frequency domain of the request signals, of the presence and/or locking signals transmitted by the identifying device, when the measured field is less than a predetermined threshold level.

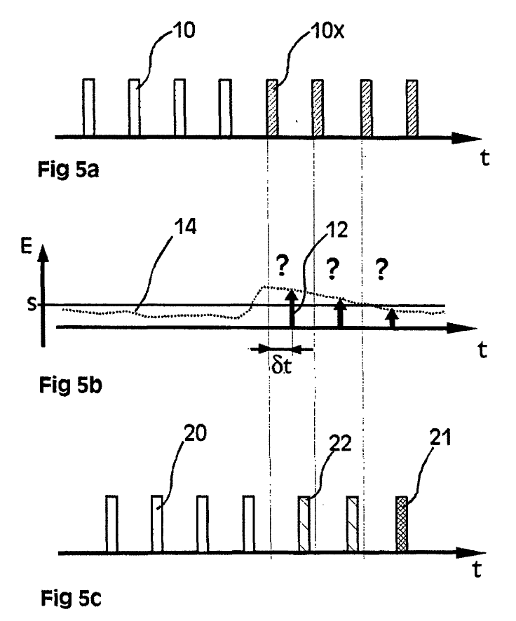

FIGS. 5a, 5b and 5c: timing diagrams respectively of the request signals transmitted by a unit on board the vehicle, of the measurements performed by the identifying device of the intensity of the ambient radio frequency field in the frequency domain of the request signals, of the presence and/or locking signals transmitted by the identifying device, when the measured field is temporarily greater than a predetermined threshold level.

According to the invention, a vehicle 1 is conventionally equipped with a hands-free locking/unlocking system, comprising a unit (not represented) on board the vehicle 1 and at least one identifying device 2, mobile relative to the vehicle 1, wherein the onboard unit transmits, during a searching period, a first periodic signal 10, called request signal, intended to be received by the identifying device 2, said identifying device being able to transmit a second signal 20, called presence signal, and a third signal 21, called locking signal, intended to be received by the onboard system.

Preferably, the first signal 10 is transmitted, to comply with the current standards and usages, in a so-called LF frequency range close to 125 kHz and second and third signals are transmitted in a so-called RF frequency range close to 433 MHz. However, other radio frequency signal frequencies can be used without compromising the operating principle of the inventive device and method.

When the identifying device 2 is in an area where it receives the first request signal 10 sent by the onboard unit, that is, at a distance D between the vehicle 1 and the identifying device 2 that is small enough to receive a radio frequency signal of intensity sufficient to be detected, it transmits a presence signal 20.

In practice, the first request signal 10 is transmitted at regular intervals Δt to form a frame 3 capable of stimulating the identifying device 2 when said identifying device approaches the vehicle and the distance D becomes less than a distance Dmax below which the reception of the first request signal 10 is possible.

In practice, as illustrated in FIG. 3, the intensity B of the signals 10a, 10b, 10c received by the identifying device 2 decreases when the distance D between the identifying device and the vehicle increases and are too weak to be received when the distance D exceeds the value Dmax.

The presence signal 20, transmitted by the identifying device 2 after each reception of a request signal 10, is received conventionally by the onboard system which, because of the response from the identifying device, places or maintains the exits of the vehicle 1 in the unlocked position.

Furthermore, the identifying device 2, which is necessarily provided with means for receiving the signals transmitted by the onboard unit, has means for measuring the intensity B of the radio frequency field in the frequency range of the request signals 10, for example in the LF range, on the antenna of the identifying device 2.

When the identifying device, which was receiving the request signals 10, stops receiving said request signals transmitted by the onboard system, that is, when the maximum duration Δt allowed (normally by construction of the device) between two successive transmissions of request signals is exceeded by a limit value δt without a request signal 10x being received, the identifying device measures the value 12 of the radio frequency field B that it receives in the frequency range of the request signal, then compares this value 12 with a threshold value S.

When the measured value 12 is less than the threshold value S as illustrated in FIG. 4b, it can be considered that the radio frequency noise level 13 is weak and therefore that it is not the cause of the failure to receive the request signals 10x. In this case, the identifying device 2 interprets the absence of request signals as a moving away from the vehicle 1 at a distance D greater than Dmax and transmits a third locking signal 21 which is interpreted by the onboard device as a situation in which the exits of the vehicle must be locked.

Obviously, the onboard system manages other parameters, such as, for example, the detection of a second identifying device or of an open exit, which can alter the ultimate behavior of the locking system. The management of these particular situations is not the subject of the present invention.

When the measured value 12 of the intensity of the radio frequency field B is greater than the threshold value S as illustrated in FIG. 5b, it can be considered that the radio frequency noise level 14 is high and that it is likely to disturb the reception of the request signals 10. The failure to detect the request signal 10x in the time interval during which said signal was expected is therefore probably caused by the appearance of an abnormally high radio frequency noise level close to the identifying device.

According to the invention, unlike what would have been done by a conventional system, the transmission by the identifying device 2 of a locking signal 21, which would have the effect of provoking the locking of the exits by the onboard device even while the identifying device 2 was at a distance D from the vehicle less than Dmax within the normal detection perimeter, or in the vehicle itself, where it could be enclosed while the owner had left the vehicle, is inhibited.

Although the expected signal 10x has not been detected, the identifying device transmits a presence signal 22 and a new cycle is therefore initiated until the moment when the following request signal is transmitted by the onboard system.

If the request signal 10 is again received by the identifying device (case not represented), the latter again transmits the presence signal 20. If the measured noise level becomes less than the threshold S and no request signal is received, then the identifying device transmits a locking signal 21 as shown in FIGS. 5a, 5b and 5c.

The intensity B of the radio frequency field can be measured in a number of ways. In a first method, the measurement is done by the identifying device 2 after the period during which a request signal should have been received, preferably a short time delay δt after, and it has not been received.

In a second embodiment, the intensity B of the radio frequency field in the frequency range of the request signals is measured continuously or with a sampling period equal to or less than that of transmission of the request signals. According to this second embodiment, the value of the intensity B of the measured radio frequency field can be estimated, by conventional signal filtering and processing methods, at the moment when the request signal should have been received.

The value S of the intensity threshold of the radio frequency field above which the identifying device inhibits the transmission of the locking signal is, for example, fixed by construction of the identifying device. For too small a value of S, the locking signal 21 will be inhibited in the presence of a noise level that can be low (and >S) whereas the identifying device is actually at a distance D greater than Dmax for which the request signal is not normally received and because of that, prevent a locking which should take place. For too high a value of S, the locking signal 21 will be transmitted by the identifying device 2 despite a strong noise level (<S) which masks the request signal at a distance D less than Dmax for which the request signal should have been received.

Since the main risk that has to be avoided is the locking of the exits of the vehicle when the identifying device 2 is inside the vehicle 1, advantageously the threshold value S fixed by construction of the identifying device is chosen according to the intensity of the weakest signal likely to be received by the identifying device 2 within the vehicle 1. For example, the value of S is chosen between 0.5 and 2 times the value of the intensity of the request signal having this weakest value.

When the identifying device 2 is outside the vehicle 1, the value of the intensity of the request signal 10 sees its intensity decrease because of the moving away from the vehicle and the fact that often the radiated intensity is weaker outside than inside the vehicle. It is then possible that a weak signal 10c which should normally have been received by the identifying device 2 is masked by a noise level less than the threshold S and that a locking signal is transmitted by the identifying device rather than a presence signal, but this situation is not, in practice, critical because the identifying device 2 is not enclosed in the vehicle 1.

In another embodiment, the threshold value S is determined according to the signals received from the onboard unit and characteristic of the vehicle model on which the device is used. Thus, the identifying device 2 can be series produced independently of the vehicle model on which it will ultimately be used and the value of the threshold S will be determined according to the destination vehicle model taking into account the received signals.

In the cases where the identifying device 2 inhibits the transmission of the locking signal 21 because of the presence of a radio frequency noise likely to mask a request signal, the identifying device 2 can:
transmit a presence signal 20 as if the request signal had been received normally; or
transmit no signal and continue to wait for the conditions for a request signal to be definitely detectable; or
to transmit a modified presence signal 22 to inform the onboard unit that the request signal 10 has not been received and that there is an abnormally high radio frequency noise level.

In all these cases, the identifying device 2 transmits a locking signal 21 only when the request signal is not received and the radio frequency noise level is less than the threshold.

In the preferred embodiments that have just been described, the method of locking/unlocking the exits of the vehicle 1 is implemented with an identifying device 2 comprising means of measuring the intensity of the radio frequency field in the frequency range of the request signal transmitted by the onboard unit and comprising associated logic functions for managing the transmission of the locking signal. The current technology of integrated electronic circuits makes it possible, with no particular difficulty, to carry out, in an identifying device of small dimensions, the measurement of the intensity of the radio frequency signals received and the digital processing of the measured data and of the signals to be transmitted.

Unless the onboard unit uses the specific content of the presence signals 22, the onboard unit does not require modifications compared to the unit used in known solutions, which makes it possible to avoid the costs of modifying said onboard unit, as much for a new system as for an application of the solution to an existing system.

When the modification of the onboard unit is accepted, it is advantageous for the identifying device 2 to be produced in such a way as to be able to transmit the modified presence signal 22.

This modified presence signal 22 can convey an indication characteristic of the noise level measured by the identifying device. In this case, the onboard unit is informed of the presence of a high radio frequency noise level close to the identifying device 2 which makes it possible to develop specific strategies to be implemented by the onboard unit such as, for example:
acting on the transmit power of the request signals to verify the reception of said frames by the identifying device in the presence of noise;
using a visual or sound signal to inform the user of the vehicle of the particular situation.

1. A hands-free method of locking/unlocking the exits of a vehicle (1) comprising:
a) the transmission by a unit on board the vehicle (1) of a first radio frequency signal, called request signal (10);
b) the transmission by an identifying device (2), mobile relative to the vehicle (1), of a second radio frequency signal, called presence signal (20), in response to the reception of the request signal (10);
c) the transmission by the identifying device (2) of a third radio frequency signal, called a locking signal (21), if the request signal (10) is not received within a time interval within which such a request signal is expected;
characterized in that it further comprises:
d) at least one measurement by the identifying device (2) of the intensity (12) of the radio frequency field B received by said identifying device in the frequency domain of the request signal (10);
e) the inhibition of the transmission of the locking signal (21), that is, the noncompletion of the step c) of the method, if the intensity (12) of the radio frequency field B is greater than a threshold value S when the expected request signal (10) is not received.

2. The method as claimed in claim 1, wherein the intensity (12) of the radio frequency field B is measured on expiry of a time delay δt, during which an expected request signal (10x) has not been received by the identifying device (2).

3. The method as claimed in claim 1, wherein the intensity (12) of the radio frequency field B compared to the threshold value S is deduced from one or more measurements of the intensity of the radio frequency field B performed before the expiry of a time delay δt during which an expected request signal (10x) has not been received by the identifying device (2).

4. The method as claimed in claim 1, wherein the identifying device (2) transmits a presence signal (22) when the transmission of the locking signal (21) is inhibited.

5. The method as claimed in claim 4, wherein the presence signal (22) transmitted when the locking signal (21) is inhibited contains an indication characteristic of the fact that the presence signal (22) is transmitted if a request signal (10x) is not received and if there is an abnormally high noise level in the frequency domain of the request signal.

6. The method as claimed in claim 1, wherein the threshold value S of the intensity (12) of the radio frequency field B, above which the transmission of the locking signal (21) is inhibited, depends on the content of signals transmitted by the unit on board the vehicle (1).

7. A hands-free device for locking/unlocking the exits of a vehicle (1), comprising:
a unit on board the vehicle (1) suitable for transmitting a periodic radio frequency signal, called request signal (10);
at least one identifying device (2), mobile relative to the vehicle suitable for receiving the request signal, suitable for transmitting a radio frequency signal called presence signal (20) in response to the reception of a request signal (10) and suitable for transmitting at least one radio frequency signal called locking signal (21) when the identifying device (2) stops receiving request signals (10),
characterized in that the mobile identifying device (2) comprises:
means of measuring the radio frequency field B in the frequency domain of the request signals,
means for comparing the value (12) of the measured radio frequency field B with a threshold value S, and
means for inhibiting the transmission of the locking signal (21) when said value of the measured radio frequency field is greater than said threshold S, when an expected request signal (10) is not received.

8. The device as claimed in claim 7, wherein the at least one identifying device (2) comprises means for calculating a value (12) of the radio frequency field B at a given instant, based on previous measurements.

9. The method as claimed in claim 2, wherein the identifying device (2) transmits a presence signal (22) when the transmission of the locking signal (21) is inhibited.

10. The method as claimed in claim 3, wherein the identifying device (2) transmits a presence signal (22) when the transmission of the locking signal (21) is inhibited.

11. The method as claimed in claim 2, wherein the threshold value S of the intensity (12) of the radio frequency field B, above which the transmission of the locking signal (21) is inhibited, depends on the content of signals transmitted by the unit on board the vehicle (1).

12. The method as claimed in claim 3, wherein the threshold value S of the intensity (12) of the radio frequency field B, above which the transmission of the locking signal (21) is inhibited, depends on the content of signals transmitted by the unit on board the vehicle (1).

13. The method as claimed in claim 4, wherein the threshold value S of the intensity (12) of the radio frequency field B, above which the transmission of the locking signal (21) is inhibited, depends on the content of signals transmitted by the unit on board the vehicle (1).

14. The method as claimed in claim 5, wherein the threshold value S of the intensity (12) of the radio frequency field B, above which the transmission of the locking signal (21) is inhibited, depends on the content of signals transmitted by the unit on board the vehicle (1).
